(19) United States
(12) Patent Application Publication
(10) Pub. No.: US 2023/0087764 A1
(43) Pub. Date: Mar. 23, 2023

(54) FERTILIZER WITH STRESS-RESISTANT AND DISEASE-RESISTANT FUNCTIONS AND METHOD FOR PREPARING SAME

(71) Applicant: Qingdao Keguang Biological Technology Co., LTD, Qingdao (CN)

(72) Inventors: Jingqing YU, Qingdao (CN); Sha CHENG, Qingdao (CN); Hongbin ZHANG, Qingdao (CN); Yuanqing LIU, Qingdao (CN)

(73) Assignee: Qingdao Keguang Biological Technology Co., LTD, Qingdao (CN)

(21) Appl. No.: 17/939,993

(22) Filed: Sep. 8, 2022

(30) Foreign Application Priority Data
Sep. 17, 2021 (CN) 202111090815.X

(51) Int. Cl. C05B 19/00; C05B 1/02

(52) U.S. Cl. CPC C05B 19/00; C05B 1/02

(57) ABSTRACT

A fertilizer with stress-resistant and disease-resistant functions and a method for preparing the same are provided. The fertilizer with stress-resistant and disease-resistant functions is prepared from the following raw materials in parts by weight: 20-40 parts of a nitrogen fertilizer, 20-30 parts of a phosphate fertilizer, 15-20 parts of a potassium fertilizer, 1.5-3.5 parts of trace elements, 2-4 parts of potassium fulvate, 5-20 parts of sodium humate, 5-15 parts of a citric acid, 3-6 parts of sodium gluconate, 2-4 parts of chitosan oligosaccharide, 10-15 parts of garden burnet root, 5-10 parts of kadsura pepper stein, and 5-10 parts of argy wormwood leaf. The fertilizer with the stress-resistant and disease-resistant functions disclosed herein can improve the yield of wheat crops, has strong resistance to wheat scab and wheat sharp eyespot, and can also improve the drought resistance of wheat under drought stress.

### CROSS REFERENCE TO THE RELATED APPLICATIONS

This application is based upon and claims priority to Chinese Patent Application No: 202111090815.X, filed on Sep. 17, 2021, the entire contents of which are incorporated herein by reference.

### TECHNICAL FIELD

The present invention relates to the technical field of fertilizers, and in particular to a fertilizer with stress-resistant and disease-resistant functions and a method for preparing the same.

### BACKGROUND

Chemical fertilizers contribute to a grain yield increase over 40% in China. Although the chemical fertilizers have brought considerable economic benefits in terms of grain yield increase, their destructive effect on the field is increasingly hard to ignore with the enhancement of people's awareness of environmental protection. Therefore, in order to provide a more environment-friendly fertilizer, continuous innovation is required to develop novel chemical fertilizers. At present, the main orientations for the research and development of novel chemical fertilizers include: compound microbial fertilizer, plant microbe-promoting preparation, decomposition agent for straw and refuse, microbial preparation with special functions, controlled-release and slow-release fertilizer, bio-organic fertilizer, organic compound fertilizer, stable nutritious fertilizer for plants and the like. Such fertilizers have advantages of regulating pH value of soil, improving soil structure, improving physical and chemical properties and biochemical properties of soil, regulating and improving growth mechanism of crops, improving quality and properties of fertilizers, increasing the utilization rate of fertilizers and the like. The fertilizers will be further developed towards the orientations of high efficiency, added value, multi-functionality and eco-environmental protection in the future.

The traditional Chinese herbs have a long history as green pesticides, which is not a modern initiative, but a traditional ancient method that has already been inherited for thousands of years and has profound historical and cultural accumulation. In agricultural production, it is a long-standing tradition for ancient agricultural producers in China to use the traditional Chinese herbs to prepare pesticides for killing pests, preventing diseases and improving yields. Moreover, such agricultural process for killing pests and preventing diseases by using plant-derived substances is common worldwide, and can be traced back to the ancient Romans around the 6^{th} century BC, who used the juice extracted from pyrethrum to kill agricultural pests. In “The Book of Rites” compiled in the Zhou Dynasty of China, there is a historical record of “fumigating with illicium anisatum to kill pests”. An ancient prescription of “cooking hellebore root in boiling water to kill pests” is also explicitly recorded in “Essential Skill to Benefit the People”, a comprehensive book on agriculture compiled in the Wei, Jin and Southern and Northern Dynasties of China. In agricultural and medical books such as “Compendium of Materia Medica”, “Shennong's Classic of Materia Medica” and “Heavenly Creations”, there are records of Chinese ancient people preparing pesticides by using traditional plant-based Chinese herbs for preventing and controlling agricultural pests. Therefore, it can be seen that from the perspective of history and humanities, the safety, reliability and feasibility of the Chinese herbal green pesticide are indisputable. In addition, the traditional Chinese herbs are mainly composed of roots, stems, leaves, flowers and fruits of plants, are rich in organic matter and active ingredients, and can provide substances for the growth of plants that are contained in chemical fertilizers.

Therefore, how to combine safe and reliable traditional Chinese herbs with traditional chemical fertilizers to obtain novel chemical fertilizers with safety, high efficiency, eco-environmental protection and multi-functionality is a problem that we are committed to solving.

### SUMMARY

The present invention is intended to provide a novel fertilizer with characteristics of safety, high efficiency, eco-environmental protection and good stress-resistance and disease-resistance for crops.

For such purposes, the present invention provides the following technical schemes:

The present invention provides a fertilizer with stress-resistant and disease-resistant functions, prepared from the following raw materials in parts by weight: 20-40 parts of a nitrogen fertilizer, 20-30 parts of a phosphate fertilizer, 15-20 parts of a potassium fertilizer, 1.5-3.5 parts of trace elements, 2-4 parts of potassium fulvate, 5-20 parts of sodium humate, 5-15 parts of citric acid, 3-6 parts of sodium gluconate, 2-4 parts of chitosan oligosaccharide, 10-15 parts of garden burnet root, 5-10 parts of kadsura pepper stein and 5-10 parts of argy wormwood leaf.

The present invention further provides a method for preparing the fertilizer with stress-resistant and disease-resistant functions, comprising the following steps:

(1) adding water to the garden burnet root, the kadsura pepper stein and the argy wormwood leaf for extraction to obtain an extract and an herb residue;

(2) stacking the herb residue for natural compost fermentation, and drying and crushing to obtain a fermented herb residue;

(3) mixing the nitrogen fertilizer, the phosphate fertilizer, the potassium fertilizer, the trace elements, potassium fulvate, sodium humate, citric acid, sodium gluconate, chitosan oligosaccharide and the extract prepared in step (1) with the fermented herb residue to obtain a premixed fertilizer; and

(4) granulating and drying the premixed fertilizer to obtain a granulated fertilizer.

Preferably, the extraction is conducted at a temperature of 80-100° C., for a time period of 5-20 min and for 3-4 times.

Preferably, water is added for the extraction at an amount of 3-6 times the total mass of the garden burnet root, the kadsura pepper stein and the argy wormwood leaf.

Preferably, the natural compost fermentation is conducted for 1-3 months. Preferably, the fermented herb residue has a water content of 8-10 wt %, and the fermented herb residue is sieved through a 20- to 40-mesh sieve after crushing in step (2) to obtain an undersized product.

Preferably, the granulated fertilizer has a particle size of 2-3 mm.

Preferably, the granulated fertilizer has a water content of ≤5 wt %.

The fertilizer with the stress-resistant and disease-resistant functions disclosed herein can improve the yield of wheat crops, has strong resistance to wheat scab and wheat sharp eyespot, and can also improve the drought resistance of wheat under drought stress. Therefore, the present invention provides a fertilizer capable of improving stress-resistance and disease-resistance of wheat. In the present invention, the traditional Chinese herbs are added through separated additions of the extract and the fermented herb residue prepared from the Chinese herbal medicines. In the present invention, the utilization rate of the fertilizer is improved by ease of absorption of the active ingredients in the extract; as an organic matter, the fermented herb residue can influence the water-fertilizer structure of soil, prevent the active ingredients in fertilizer from seeping into the ground and losing too quickly, reduce the proportion of unavailable fertilizer and prolong the action time of fertilizer, so as to provide sufficient nutrients for crops.

### DETAILED DESCRIPTION

The present invention provides a fertilizer with stress-resistant and disease-resistant functions, prepared from the following raw materials in parts by weight: 20-40 parts of a nitrogen fertilizer, 20-30 parts of a phosphate fertilizer, 15-20 parts of a potassium fertilizer, 1.5-3.5 parts of trace elements, 2-4 parts of potassium fulvate, 5-20 parts of sodium humate, 5-15 parts of citric acid, 3-6 parts of sodium gluconate, 2-4 parts of chitosan oligosaccharide, 10-15 parts of garden burnet root, 5-10 parts of kadsura pepper stein and 5-10 parts of argy wormwood leaf.

In the present invention, the fertilizer with stress-resistant and disease-resistant functions is preferably prepared from the following raw materials in parts by weight: 20-40 parts, more preferably 25-35 parts, and still more preferably 30 parts of the nitrogen fertilizer; 20-30 parts, more preferably 22-28 parts, and still more preferably 25 parts of the phosphate fertilizer; 15-20 parts, more preferably 16-18 parts, and still more preferably 17 parts of the potassium fertilizer; 1.5-3.5 parts, more preferably 2-3 parts, and still more preferably 2.5 parts of the trace elements; 2-4 parts, more preferably 2.5-3.5 parts, and still more preferably 3 parts of potassium fulvate; 5-20 parts, more preferably 10-15 parts, and still more preferably 12 parts of sodium humate; 5-15 parts, more preferably 8-12 parts, and still more preferably 10 parts of citric acid; 3-6 parts, more preferably 4-5 parts, and still more preferably 4.5 parts of sodium gluconate; 2-4 parts, more preferably 2.5-3.5 parts, and still more preferably 3 parts of chitosan oligosaccharide; 10-15 parts, more preferably 11-14 parts, and still more preferably 12 parts of the garden burnet root; 5-10 parts, more preferably 7-9 parts, and still more preferably 8 parts of the kadsura pepper stein; and 5-10 parts, more preferably 6-9 parts, and still more preferably 7 parts of the argy wormwood leaf.

In the present invention, the nitrogen fertilizer is preferably one or more of ammonium chloride, ammonium nitrate and urea, and more preferably ammonium nitrate and/or urea; the phosphate fertilizer is preferably calcium superphosphate and/or monopotassium phosphate, and more preferably monopotassium phosphate; the potassium fertilizer is preferably potassium chloride and/or potassium sulfate, and more preferably potassium chloride; the trace element is preferably copper sulfate, boric acid, molybdic acid and magnesium sulfate.

In the present invention, the mass ratio of copper sulfate, boric acid, molybdic acid and magnesium sulfate is preferably (0.3-1.0):(0.4-0.8):(0.4-0.5):(0.3-1.2), and more preferably 0.8:0.5:0.4:0.8.

The present invention further provides a method for preparing the fertilizer with stress-resistant and disease-resistant functions, comprising the following steps:

(1) adding water to the garden burnet root, the kadsura pepper stein and the argy wormwood leaf for extraction to obtain an extract and an herb residue;

(2) stacking the herb residue for natural compost fermentation, and drying and crushing to obtain a fermented herb residue;

(3) mixing the nitrogen fertilizer, the phosphate fertilizer, the potassium fertilizer, the trace elements, potassium fulvate, sodium humate, citric acid, sodium gluconate, chitosan oligosaccharide and the extract prepared in step (1) with the fermented herb residue to obtain a premixed fertilizer; and

(4) granulating and drying the premixed fertilizer to obtain a granulated fertilizer.

After years of research and development, it is determined that a traditional Chinese herbal composition composed of garden burnet root, kadsura pepper stein and argy wormwood leaf can provide superior stress-resistance and disease-resistance for wheat crops when used in combination with chemical fertilizers. As the fermented herb residue is added into the chemical fertilizers, i.e., the chemical fertilizer and organic fertilizer are used in combination, the destructive effect of the chemical fertilizers on soil is reduced, and the absorption and utilization rate of the fertilizer by crops is also improved.

In the present invention, the active ingredients in the traditional Chinese herbal composition and the herb residue are treated separately. Firstly, water is added to the garden burnet root, the kadsura pepper stein and the argy wormwood leaf are added for extraction to obtain an extract and an herb residue.

In the present invention, the extraction is preferably conducted at a temperature of 80-100° C., more preferably 85-95° C., and still more preferably 90° C.

In the present invention, the extraction is preferably conducted for a time period of 5-20 min, more preferably 10-15 min, and still more preferably 15 min.

In the present invention, the extraction is conducted 3-4 times, and more preferably 4 times.

In the present invention, water is added for the extraction at an amount of 3-6 times, more preferably 4-5 times, and still more preferably 5 times the total mass of the garden burnet root, the kadsura pepper stein and the argy wormwood leaf.

In the present invention, the separation of the extract and the herb residue is preferably centrifugal separation.

In the present invention, the speed of the centrifugal separation is preferably 8,000-10,000 r/min, and more preferably 8,500 r/min.

In the present invention, the time for the centrifugal separation is preferably 20-40 min, and more preferably 30 min.

The herb residue obtained after separation is made into an herb residue compost, which is then left for natural compost fermentation.

In the present invention, the water content of the herb residue is adjusted to 45-65 wt %, and more preferably 50 wt % before fermentation.

In the present invention, the water content of the herb residue is adjusted by adding water directly until the required water content is reached.

In the present invention, the ratio of the height, length and width of the herb residue compost is preferably (1.5-2):(2.5-3.5):(1.5-2.5), and more preferably 1.8:3:2. Preferably, the herb residue compost has a height not more than 2 m.

In the present invention, the temperature of the natural compost fermentation is controlled at 55-65° C., and more preferably 60° C. If the temperature is too high, the compost is turned for heat dissipation.

In the present invention, the natural compost fermentation is conducted for preferably 1-3 months, and more preferably 3 months.

After the fermentation is completed, the resulting fermentation product is dried and crushed to obtain a fermented herb residue.

In the present invention, the drying temperature is preferably 60-65° C., and more preferably 65° C.

In the present invention, after drying, the fermented herb residue preferably has a water content of 8-10 wt %, more preferably 9 wt %.

In the present invention, the crushing is conducted using a crusher.

In the present invention, the crushed fermentation product is sieved with a 20- to 40-mesh sieve, and preferably a 30-mesh sieve, and the undersized product is the fermented herb residue.

The fermentation time of the fermented herb residue is long, while the extract from the same batch of medicinal materials has limited preservation time. Therefore, the extract and the herb residue used for preparing the fertilizer disclosed herein can be obtained from different batches of materials. Alternatively, if available, the extract of the same batch of materials can be cryopreserved. After the fermentation of the herb residue of the same batch of materials is completed, the cryopreserved extract can be taken out to prepare the fertilizer.

In the present invention, the nitrogen fertilizer, the phosphate fertilizer, the potassium fertilizer, the trace elements, potassium fulvate, sodium humate, citric acid, sodium gluconate, chitosan oligosaccharide and the prepared extract are mixed with the fermented herb residue to obtain a premixed fertilizer. The premixed fertilizer is granulated and dried to obtain a granulated fertilizer.

In the present invention, after granulation, the granulated fertilizer preferably has a particle size of 2-3 mm, more preferably 3 mm.

In the present invention, after drying, the granulated fertilizer preferably has a water content less than 5 wt %.

The technical schemes provided in the present invention will be described in detail below with reference to the examples, which, however, should not be construed as limiting the scope of the present invention.

### EXAMPLE 1

12 parts of garden burnet root, 8 parts of kadsura pepper stein and 7 parts of argy wormwood leaf were mixed, and water of 5 times the total mass of the garden burnet root, the kadsura pepper stein and the argy wormwood leaf was added. The resulting mixture was extracted at 90° C. for 15 min, and then centrifuged in a centrifuge at 8,500 r/min for 30 min to obtain an extract and an herb residue. Then the herb residue was subjected to 4 repeated extractions according to the above water amount, extraction conditions and the centrifugation conditions, and the extracts obtained from the 4 repeated extractions were combined, frozen in a freezer, and preserved at −20° C. for later use. The water content of the herb residue obtained from the 4^{th} centrifugal separation was adjusted to be 50 wt %, and an herb residue compost was made according to a ratio of height:length:width=1.8:3:2 for natural compost fermentation. The temperature of the herb residue compost was maintained at 55-65° C. during the fermentation process of 3 months. Then the fermented herb residue was placed into an oven and dried at 65° C. until the water content was 9 wt %. The dried fermented herb residue was crushed and sieved through a 30-mesh sieve, and the undersized product was taken as the fermented herb residue. 30 parts of urea, 25 parts of monopotassium phosphate, 17 parts of potassium chloride, 2.5 parts of trace elements (wherein the mass ratio of copper sulfate, boric acid, molybdic acid and magnesium sulfate was 0.8:0.5:0.4:0.8), 3 parts of potassium fulvate, 12 parts of sodium humate, 10 parts of citric acid, 4.5 parts of sodium gluconate and 3 parts of chitosan oligosaccharide were weighed. The previously frozen and preserved extract was thawed. Then the above raw materials were added to the fermented herb residue, and the resulting mixture was mixed well to obtain a premix. The premix was prepared into a granulated fertilizer with a particle size of 3 mm and a water content ≤5 wt %.

### EXAMPLE 2

10 parts of garden burnet root, 5 parts of kadsura pepper stein and 10 parts of argy wormwood leaf were mixed, and water of 4 times the total mass of the garden burnet root, the kadsura pepper stein and the argy wormwood leaf was added. The resulting mixture was extracted at 100° C. for 10 min, and then centrifuged in a centrifuge at 8,000 r/min for 20 min to obtain an extract and an herb residue. Then the herb residue was subjected to 3 repeated extractions according to the above water amount, extraction conditions and the centrifugation conditions, and the extracts obtained from the 3 repeated extractions were combined, frozen in a freezer, and preserved at −20° C. for later use. The water content of the herb residue obtained from the 3^{rd} centrifugal separation was adjusted to be 45 wt %, and an herb residue compost was made according to a ratio of height:length:width=1.5:2.5:2.5 for natural compost fermentation. The temperature of the herb residue compost was maintained at 55-65° C. during the fermentation process of 2 months. Then the fermented herb residue was placed into an oven and dried at 60° C. until the water content was 8 wt %. The dried fermented herb residue was crushed and sieved through a 40-mesh sieve, and the undersized product was taken as the fermented herb residue. 20 parts of ammonium nitrate, 30 parts of calcium superphosphate, 5 parts of potassium sulfate, 1.5 parts of trace elements (wherein the mass ratio of copper sulfate, boric acid, molybdic acid and magnesium sulfate was 0.4:0.3:0.3:0.5), 2 parts of potassium fulvate, 20 parts of sodium humate, 8 parts of citric acid, 3 parts of sodium gluconate and 4 parts of chitosan oligosaccharide were weighed. The previously frozen and preserved extract was thawed. Then the above raw materials were added to the fermented herb residue, and the resulting mixture was mixed well to obtain a premix. The premix was prepared into a granulated fertilizer with a particle size of 3 mm and a water content ≤5 wt %.

### EXAMPLE 3

15 parts of garden burnet root, 10 parts of kadsura pepper stein and 9 parts of argy wormwood leaf were mixed, and water of 6 times the total mass of the garden burnet root, the kadsura pepper stein and the argy wormwood leaf was added. The resulting mixture was extracted at 80° C. for 20 min, and then centrifuged in a centrifuge at 10,000 r/min for 40 min to obtain an extract and an herb residue. Then the herb residue was subjected to 4 repeated extractions according to the above water amount, extraction conditions and the centrifugation conditions, and the extracts obtained from the 4 repeated extractions were combined, frozen in a freezer, and preserved at −20° C. for later use. The water content of the herb residue obtained from the 4^{th} centrifugal separation was adjusted to be 65 wt %, and an herb residue compost was made according to a ratio of height:length:width=2:3.5:2.5 for natural compost fermentation. The temperature of the herb residue compost was maintained at 60° C. during the fermentation process of 3 months. Then the fermented herb residue was placed into an oven and dried at 65° C. until the water content was 10 wt %. The dried fermented herb residue was crushed and sieved through a 20-mesh sieve, and the undersized product was taken as the fermented herb residue. 20 parts of ammonium nitrate, 20 parts of urea, 20 parts of calcium superphosphate, 20 parts of potassium chloride, 3.5 parts of trace elements (wherein the mass ratio of copper sulfate, boric acid, molybdic acid and magnesium sulfate was 1.0:0.8:0.5:1.2), 4 parts of potassium fulvate, 10 parts of sodium humate, 15 parts of citric acid, 6 parts of sodium gluconate and 2 parts of chitosan oligosaccharide were weighed. The previously frozen and preserved extract was thawed. Then the above raw materials were added to the fermented herb residue, and the resulting mixture was mixed well to obtain a premix. The premix was prepared into a granulated fertilizer with a particle size of 2 mm and a water content ≤5 wt %.

### Test Example 1

Test site: Dujia Henggou village, Yanghe Town, Jiaozhou, Qingdao, Shandong, China;

Test period: October 2019 to June 2020;

Test crops: Wheat; variety: Shimai 26;

Test fertilizers: the 3 granulated fertilizers prepared in Examples 1-3 of the present invention were used as test groups;

and 3 comparative examples were set as control groups, wherein:

Comparative Example 1 was a chemical fertilizer group similar to Example 1 of the present invention without the addition of garden burnet root, kadsura pepper stein and argy wormwood leaf, comprising: 30 parts of urea, 25 parts of monopotassium phosphate, 17 parts of potassium chloride, 2.5 parts of trace elements (wherein the mass ratio of copper sulfate, boric acid, molybdic acid and magnesium sulfate was 0.8:0.5:0.4:0.8), 3 parts of potassium fulvate, 12 parts of sodium humate, 10 parts of citric acid, 4.5 parts of sodium gluconate and 3 parts of chitosan oligosaccharide. The resulting mixture was mixed well and prepared into granules with a particle size of 3 mm which were subsequently dried until the water content fell to ≤5 wt %;

Comparative Example 2 was a group of chemical fertilizer with addition of the extract of garden burnet root, kadsura pepper stein and argy wormwood leaf, but without addition of the fermented herb residue, comprising: 30 parts of urea, 25 parts of monopotassium phosphate, 17 parts of potassium chloride, 2.5 parts of trace elements (wherein the mass ratio of copper sulfate, boric acid, molybdic acid and magnesium sulfate was 0.8:0.5:0.4:0.8), 3 parts of potassium fulvate, 12 parts of sodium humate, 10 parts of citric acid, 4.5 parts of sodium gluconate and 3 parts of chitosan oligosaccharide, as well as the extract prepared according to the process of Example 1 from 12 parts of garden burnet root, 8 parts of caulis piperis futokadsurae and 7 parts of argy wormwood leaf. The above components were mixed well and prepared into granules with a particle size of 3 mm which were subsequently dried until the water content fell to ≤5 wt %;

In Comparative Example 3, garden burnet root, kadsura pepper stein and argy wormwood leaf were also added, but were not processed by extraction. Instead, 12 parts of garden burnet root, 8 parts of kadsura pepper stein and 7 parts of argy wormwood leaf were directly fermented according to the process of Example 1 to obtain a fermentation product. The obtained fermentation product was dried until the water content was 9 wt %, and crushed and sieved through a 30-mesh sieve. The undersized product was mixed with 30 parts of urea, 25 parts of monopotassium phosphate, 17 parts of potassium chloride, 2.5 parts of trace elements (wherein the mass ratio of copper sulfate, boric acid, molybdic acid and magnesium sulfate was 0.8:0.5:0.4:0.8), 3 parts of potassium fulvate, 12 parts of sodium humate, 10 parts of citric acid, 4.5 parts of sodium gluconate and 3 parts of chitosan oligosaccharide. The resulting mixture was mixed well and prepared into granules with a particle size of 3 mm which were subsequently dried until the water content fell to ≤5 wt %.

Test plots: 6 test regions corresponding to the test groups and the comparative groups were set up in a field, each containing 3 replicates, for a total of 18 plots; and the area of each plot was 50 m².

Fertilization mode: the granulated fertilizers prepared in Examples 1-3 and the fertilizers prepared in Comparative Examples 1-3 were used as starter fertilizers; the starter fertilizers were applied at 3.5 kg/50 m² during soil preparation in autumn; in addition, topdressing was applied at the tillering stage and the jointing stage of wheat, with 4 kg/50 m² of urea applied at the tillering stage and 3 kg/50 m² of urea at the jointing stage.

Field management: The filed was irrigated with frozen water once after sowing in autumn, spring water after the wheat turned green in the beginning of spring, jointing water after half a month, and grouting water during flowering; a 50% pirimicarb wettable powder (3,500-fold diluted solution) was used to prevent and control wheat aphids by spraying, and a 50% phoxim EC (2,000-fold diluted solution) was used to prevent and control armyworms by spraying.

The data of ear number per mu, grain number per ear, weight per 1,000 grains and yield per mu of each group were summarized, and the yield increase of each test group relative to the group of Comparative Example 1 (chemical fertilizer) was calculated. The results are shown in Table 1.

TABLE 1
Yield of test groups and comparative groups

| | Comparative | Comparative | Comparative | Example | Example | Example |
|---|---|---|---|---|---|---|
| Groups | Example 1 | Example 2 | Example 3 | 1 | 2 | 3 |
| Ear number | 43.6 | 44.0 | 44.0 | 44.9 | 45.3 | 44.5 |
| per mu | | | | | | |
| (×10,000) | | | | | | |
| Grain | 32.5 | 32.0 | 33.4 | 35.5 | 36.0 | 35.9 |
| number per | | | | | | |
| ear (grain) | | | | | | |
| Weight per | 37.2 | 36.3 | 38.5 | 44.0 | 42.8 | 43.5 |
| 1,000 grains | | | | | | |
| (g) | | | | | | |
| Yield per | 520.5 | 510.6 | 557.2 | 690.5 | 688.0 | 680.7 |
| mu (kg) | | | | | | |
| Yield | — | — | — | 32.7% | 32.2% | 30.8% |
| increase | | | | | | |
| (%) | | | | | | |

As can be seen from Table 1, Examples 1-3 significantly increased the grain number per ear and weight per 1,000 grains relative to Comparative Examples 1-3, and the yield per mu of Examples 1-3 was increased by 32.7%, 32.2% and 30.8%, respectively, relative to that of Comparative Example 1.

In addition, during the test period, the disease situation of each group was also summarized in this test example. The results showed that scab and sharp eyespot were found in groups of Comparative Examples 1-3. The statistics of specific disease situation are shown in Table 2 below.

TABLE 2
Disease situation of scab and sharp eyespot in test groups and
comparative groups

| | | | | Total | Sharp | |
|---|---|---|---|---|---|---|
| | Total | Scab | | number of | eyespot | Sharp |
| | number of | Number | Scab | plants | Number | eyespot |
| | ears | of | Percentage | surveyed | of | Percentage |
| | surveyed | diseased | diseased | for sharp | diseased | diseased |
| | for scab | ears | ear (%) | eyespot | plants | plant (%) |
| Comparative | 1000 | 112 | 11.2% | 1000 | 55 | 5.5% |
| Example 1 | | | | | | |
| Comparative | 1000 | 99 | 9.9% | 1000 | 20 | 2.0% |
| Example 2 | | | | | | |
| Comparative | 1000 | 85 | 8.5% | 1000 | 22 | 2.2% |
| Example 3 | | | | | | |
| Example 1 | 1000 | 0 | 0 | 1000 | 0 | 0 |
| Example 2 | 1000 | 0 | 0 | 1000 | 0 | 0 |
| Example 3 | 1000 | 18 | 1.8% | 1000 | 5 | 0.5% |

As can be seen from Table 2, Examples 1-2 of the present invention were not infected with scab and sharp eyespot, indicating that the granulated fertilizer of the present invention can improve the disease resistance of wheat; it was found by investigation that the infection in the group of Example 3 might be due to the proximity to the region of Comparative Example 1, and the plants of Example 3 were thus affected by the diseased wheat of Comparative Example 1. However, it can also be seen from the test of Example 3 that the percentage of diseased ear and diseased plant of Example 3 were lower in the case of both scab and sharp eyespot infections, indicating that the use of the granulated fertilizer of the present invention can improve the disease resistance of wheat.

### Test Example 2

In the same period and at the same site of test example 1, the following tests were conducted:

Test group: In the process of field management, the field was only irrigated with the frozen water once after sowing in autumn, without irrigation with the spring water after the wheat turned green in the beginning of spring as well as the jointing water and the grouting water; other conditions were the same as those in Example 1;

Control group 1: In the process of field management, the field was only irrigated with the frozen water once after sowing in autumn, without irrigation with the spring water after the wheat turned green in the beginning of spring as well as the jointing water and the grouting water; other conditions were the same as those in Comparative Example 1;

Control group 2: In the process of field management, the field was only irrigated with the frozen water once after sowing in autumn, without irrigation with the spring water after the wheat turned green in the beginning of spring as well as the jointing water and the grouting water; other conditions were the same as those in Comparative Example 2;

Control group 3: In the process of field management, the field was only irrigated with the frozen water once after sowing in autumn, without irrigation with the spring water after the wheat turned green in the beginning of spring as well as the jointing water and the grouting water; other conditions were the same as those in Comparative Example 3.

After the completion of the test, the data of ear number per mu, grain number per ear, weight per 1,000 grains and yield per mu of test group and control groups 1-3 were summarized, and the yield increase of each group relative to the group of Comparative Example 1 (chemical fertilizer) was calculated. The results are shown in Table 3.

TABLE 3
Yield of test group and control groups

| | Control | Control | Control | Test |
|---|---|---|---|---|
| Groups | group 1 | group 2 | group 3 | group |
| Ear number | 35.6 | 35.7 | 42.0 | 43.5 |
| per mu | | | | |
| (×10,000) | | | | |
| Grain number | 25.5 | 28.0 | 28.4 | 33.5 |
| per ear (grain) | | | | |
| Weight per | 30.2 | 33.3 | 32.5 | 38.0 |
| 1,000 | | | | |
| grains (g) | | | | |
| Yield per | 265.5 | 330.0 | 380.7 | 542.5 |
| mu (kg) | | | | |
| Yield | 49.0% | 35.4% | 31.7% | 21.4% |
| reduction | | | | |
| (%) | | | | |

Note:
The yield reductions of the control groups 1-3 and test group in this table are relative to the yields of Comparative Examples 1-3 and Example 1 in Test Example 1, respectively.

As can be seen from Table 3, the test group using the granulated fertilizer of the present invention reached a higher yield even under drought stress conditions, indicating that the granulated fertilizer of the present invention can improve drought resistance of wheat as compared with Comparative Examples 1-3.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A fertilizer with stress-resistant and disease-resistant functions, wherein the fertilizer is prepared from the following raw materials in parts by weight: 20-40 parts of a nitrogen fertilizer, 20-30 parts of a phosphate fertilizer, 15-20 parts of a potassium fertilizer, 1.5-3.5 parts of trace elements, 2-4 parts of potassium fulvate, 5-20 parts of sodium humate, 5-15 parts of a citric acid, 3-6 parts of sodium gluconate, 2-4 parts of chitosan oligosaccharide, 10-15 parts of garden burnet root, 5-10 parts of kadsura pepper stein, and 5-10 parts of argy wormwood leaf.

2. A method for preparing the fertilizer with the stress-resistant and disease-resistant functions according to claim 1, comprising the following steps:
(1) adding water to the garden burnet root, the kadsura pepper stein, and the argy wormwood leaf for an extraction to obtain an extract and an herb residue;
(2) stacking the herb residue for a natural compost fermentation, and drying and crushing a resulting product to obtain a fermented herb residue;
(3) mixing the nitrogen fertilizer, the phosphate fertilizer, the potassium fertilizer, the trace elements, the potassium fulvate, the sodium humate, the citric acid, the sodium gluconate, the chitosan oligosaccharide, and the extract prepared in step (1) with the fermented herb residue to obtain a premixed fertilizer; and
(4) granulating and drying the premixed fertilizer to obtain a granulated fertilizer.

3. The method according to claim 2, wherein the extraction is conducted at a temperature of 80-100° C. for a time period of 5-20 min 3-4 times.

4. The method according to claim 3, wherein the water is added for the extraction at an amount of 3-6 times a total mass of the garden burnet root, the kadsura pepper stein, and the argy wormwood leaf.

5. The method according to claim 4, wherein the natural compost fermentation is conducted for 1-3 months.

6. The method according to claim 5, wherein the fermented herb residue has a water content of 8-10 wt %, and the fermented herb residue is sieved through a 20- to 40-mesh sieve after crushing in step (2) to obtain an undersized product.

7. The method according to claim 6, wherein the granulated fertilizer has a particle size of 2-3 mm.

8. The method according to claim 2, wherein the granulated fertilizer has a water content of ≤5 wt %.

9. The method according to claim 3, wherein the granulated fertilizer has a water content of ≤5 wt %.

10. The method according to claim 4, wherein the granulated fertilizer has a water content of ≤5 wt %.

11. The method according to claim 5, wherein the granulated fertilizer has a water content of ≤5 wt %.

12. The method according to claim 6, wherein the granulated fertilizer has a water content of ≤5 wt %.

13. The method according to claim 7, wherein the granulated fertilizer has a water content of ≤5 wt %.
